(19) United States
(12) Patent Application Publication
(10) Pub. No.: US 2010/0009324 A1
(43) Pub. Date: Jan. 14, 2010

(54) METHOD AND DEVICE FOR POST CLINICAL TREATMENT OF DEPENDENCY RELAPSES

(75) Inventors: E. Keith Owens, Newport Beach, CA (US); Trung M. Thai, Huntington Beach, CA (US)

Correspondence Address: FULWIDER PATTON LLP, HOWARD HUGHES CENTER, 6060 CENTER DRIVE, TENTH FLOOR, LOS ANGELES, CA, 90045, US

(73) Assignees: E. Keith Owens, Newport Beach, CA (US); Trung M. Thai, Huntington Beach, CA (US)

(21) Appl. No.: 12/172,856

(22) Filed: Jul. 14, 2008

(51) Int. Cl. G09B 19/00

(52) U.S. Cl. 434/236

(57) ABSTRACT

Selecting a portable recording device having a selection menu with controls coordinated with an index to recall therapeutic signals to reproduce stimuli corresponding with pre-recorded stimuli to treat the patient.

### FIELD OF THE INVENTION

The present invention concerns the field of rehabilitative therapy methods and devices, and particularly those methods and devices adapted to influence physiological mannerisms in order to achieve a desired effect, such as by treating dependency relapses by stimulation or relaxation of a patient.

### BACKGROUND OF THE INVENTION AND STATE OF THE ART

Substance use and abuse has existed for thousands of years, and humans have persistently sought treatment of addictive behaviors and dependency related problems. Addiction occurs in people of all ages and backgrounds and at every socio-economic level, and widespread use of addicting drugs is one of the major problems facing modern society. Addiction may be, for instance, the abuse of alcohol, cocaine, heroin, marijuana, methamphetamines, opiates, prescription drugs, club drugs (ecstasy) and many others. In the United States, alcoholism is the most serious in terms of economic loss, loss in productivity, and psychological damage to individuals and families. Tens of millions of people in this country are afflicted with serious drinking problems. Excessive alcohol abuse is the 3rd leading lifestyle-related cause of death for people in the United States each year. The use of narcotic drugs, particularly among the younger people, is equally concerning. In 2002, nearly 6 million U.S. residents reported symptoms of drug dependence or abuse. In a Department of Justice 2004 Survey of Inmates in State and Federal Correctional Facilities, 32% of State prisoners and 26% of Federal prisoners said they had committed their current offense while under the influence of drugs, and about 56% of State prisoners without mental health problems were dependent on or abused alcohol or drugs.

It is recognized, however, that addiction is a treatable disorder. Conventional rehabilitative treatment programs typically involve behavioral therapies such as clinical therapy, certified therapeutic counseling strategies, licensed chemical dependency counselors, drug addiction and substance abuse counselors, psychiatrists, insurance based drug rehabs, hospital based drug abuse counseling and alcohol abuse counseling, in-patient rehabilitation programs, out-patient rehabilitation programs, therapeutic communities, twelve step support groups, ALCOHOLICS ANONYMOUS, NARCOTICS ANONYMOUS, 12 step meetings, and halfway houses. Like people with diabetes or heart disease, people in treatment for alcohol or drug addiction learn behavioral changes and may even take medication as part of their treatment regimen. Through treatment tailored to the individual needs, patients can learn to control their condition and live normal productive lives.

Extensive research and work has been performed in the area of alcohol and drug rehabilitation, and involve various techniques for treating a patient. It is generally accepted that targeted therapy at a treatment center may be necessary to isolate those everyday occurrences that trigger the particular addictive behavior and which are treatable at a clinic. Neuroscience seeks to improve on the treatment of patients. Neuroscience is a multidisciplinary field of science at the frontier of investigating the brain and mind. Studies of the brain have been undertaken to achieve an understanding of how patients perceive and interact with the external world and, in particularly, how patient experience and human biology influence each other. Numerous studies have been undertaken in the United States and around the world to gain a better understanding of how human cognition (reasoning and logic) and emotion are mapped to specific neural circuitries, literally mapping the behavior of patients to their brainwaves and functions as non-invasive approaches to changing the malfunctioning areas of the brain are sought.

It is believed that for many people successful, long term recovery requires more than seeking to force the patient to change their behavior or “choosing” not to drink or use drugs. It is believed necessary to treat the underlying mental health issues such as anxiety, depression, learning disabilities, attention-deficit hyperactivity disorder (ADHD), obsessive compulsive disorder, post traumatic stress disorder (PTSD), or bipolar disorder along with the addiction, or the patient may face a lifetime of chronic relapses. These underlying mental health issues are sometimes referred to as co-occurring disorders.

Modern addiction rehabilitation has focused on biofeedback as a means for treatment. In biofeedback procedures a sensor is used to translate an unconscious biological signal into another form of signal that is easier to be detected (sight or sound). For instance, a smoker in the presence of stress tends to reactively reach to a pack of cigarettes. If the cigarette pack is connected with a bell such that every time the pack is lifted the bell rings the smoker will become aware of his or her automatic behavior. Through the real-time sensing of the automatic behavior in response to an addicting cue the smoker will ultimately learn how to modulate the unconscious signal.

Studies show that treatment for addiction using biofeedback combined with responsible medication management is often needed to reduce cravings and mental distractions that might otherwise limit successful recovery. Cognitive Behavioral Therapy (CBT), a form of biofeedback at the cognitive level, combined with approved medication has been shown to reduce death rates and many health problems associated with drug and alcohol abuse. CBT is a kind of psychotherapy based on the concept of how patients think (Cognition), how they feel (Emotion), and how they act (Behavior), all interacting together. CBT is typically utilized in therapy sessions to help patients recognize why they are using alcohol or drugs and to determine what they need to do to either avoid or cope with whatever triggers their use. This requires a careful analysis of the circumstances of each episode so as to make the appropriate skills and resources available to the patient to facilitate recovery. CBT is used to treat a wide range of psychological problems, including depression, anxiety, anger, substance abuse, alcohol abuse and personality problems.

In CBT, it is assumed that individuals essentially learn to become alcohol or drug abusers. During CBT patients learn to respond in new, and unfamiliar ways by practicing positive behavior such as how to refuse an offer of drugs or how to break off a relationship with drug using associates. Patients develop meaningful alternatives to drug abuse, that is, other activities and hobbies. The therapist shows the patient how to recognize and change a “conditioned response,” i.e. using drugs after an argument with a spouse or having a drink after a bad day at work. This CBT is intended to provide the foundation for long-term recovery from addiction and co-occurring disorders by teaching the skills necessary for the patient to recognize and change the negative thoughts and emotions that lead to destructive behavior.

Neurodevelopment is a proven, non-medication method of improving specific brain processing issues that uses electroencephalogram (EEG) based neurofeedback to correct and enhance brain-processing skills. EEG is the neurophysiological measurement of the electrical activity of the brain by recording from electrodes placed on the scalp. The resulting traces are known as an EGG and present an electrical signal from a large number of neutrons or “brainwaves”. The EEG is a measure of the brain function by physiology rather than a measure of brain structure or anatomy like the MRI scan and is a standard procedure available in most hospitals and clinics around the world, typically used to evaluate epileptic seizures.

Relying on a patient's symptoms can often lead to misdiagnosis and/or ineffective medications and treatments. Those working in the field have taken advantage of advancements in computer science and statistical modeling to improve upon traditional EEG allowing neuroscientists in the field to identify common patterns and deviations that can be linked to specific disorders. These EEG characteristics can be used to gain objective, evidence based insight and to what is actually happening inside the brain and certain measurable, scientific solutions which help re-train the brain to reach its full potential. By using this quantitative EEG, referred to in the work of the assignee of the present invention as “rEEG”, treatment professionals have actual biological indicators to diagnose and treat behavioral and mental disorders.

Relapse prevention using neurofeedback (RPNF) helps a patient to identify brain waves associated with the mental state of relapse in the presence of addicting cues. Using rEEG combined with the help of a therapist, the patient learns to use mindfulness to steer away from the mental state of addiction. The patient learns how to create a mental state of relaxation and clarity in the presence of the addicting cues, and the cues ultimately lose their power of temptation. RPNF brings an automatic behavior to the level of consciousness so that the patient is aware of the behavior and can learn to control it in the hear and now spectrum by consciously changing his or her brain waves.

Various treatment methods have been devised and several patents have been published for devices and methods of monitoring and/or modifying behavior through neurofeedback/biofeedback, such systems and patents being incorporated herein by reference. U.S. Pat. No. 6,662,032 to Gavish et al. describes an apparatus for improving the health of a user. The apparatus includes a first sensor, adapted to measure a first physiological variable, which is indicative of a voluntary action of the user, and a second sensor adapted to measure a second physiological variable, which is substantially governed by an autonomic nervous system of the user. Circuitry is adapted to receive respective first and second sensor signals from the first and second sensors, and is responsive thereto, to generate an output signal which directs the user to modify a parameter of a selected voluntary action.

U.S. Pat. No. 5,076,281 to Gavish, which is incorporated herein by reference, describes a biorhythmic modulator, consisting of a sensor for monitoring biorhythmic activity of the body of a user, a circuit for continuously analyzing the biorhythmic activity and producing parameter signals based upon a biorhythmic activity, a circuit for generating selectable sound-code pattern signals, a central processing unit (CPU) connected to receive signals from both the activity characteristic parameters producing circuit and the selected sound patterns generating circuit, and to feed the signals of the parameters and patterns to a sound pattern synthesizer for producing music-like sound pattern signals, transduceable into audible music-like patterns, and having a rhythm which is non-identical to the rhythm of the biorhythmic activity.

U.S. Pat. No. 5,267,942 to Saperston, which is incorporated herein by reference, describes a method for interactively entraining a patient's heart rate to a target rate or frequency which includes the steps of determining the patient's heart rate through a heart rate monitor and exposing the patient to music having a tempo. Similar methods can be used to entrain respiration rate and fundamental brain wave frequencies.

U.S. Pat. No. 7,207,935 to Lipo, which is incorporated herein by reference, describes a method and device for presenting music to a patient in real time synchrony with relation to every single pulse of the patient's heartbeat, thereby inducing an enjoyable and relaxing sensation. A digitized electric signal representative of the patient's heartbeat is fed to a microprocessor which brings the digitized electric signal into correspondence with a sequence of musical sound configurations so that each pulse beat is followed by one of the sound configurations in real time. The sequence of musical sound configurations is presented to the patient so that each sound configuration is played in real-time synchrony with a respective pulse beat.

U.S. Pat. No. 6,026,322 to Koreman et al., which is incorporated herein by reference, describes an apparatus and a program designed to train the user to control one or more aspects of his or her psycho-physiological state is controlled by signals representative of a psycho-physiological parameter of the user, e.g. galvanic skin resistance, detected by a sensor unit with two contacts on adjacent fingers of a patient. The apparatus is described for use in treating patients with a physiological condition, for example, irritable bowel syndrome. In a treatment session, one or more psycho-physiological parameters of the patient is sensed to alter a display watched by the patient. The display includes a visual or pictorial representation of the physiological condition being treated which changes in appearance in a fashion corresponding to the physiological change desired in the patient.

U.S. Pat. No. 6,623,427 to Mandigo, which is incorporated herein by reference, describes a personal entertainment system calibrated and controlled by the biological or physiological condition of a user. The entertainment system includes a media player; a sensor operative to detect biological parameters and generating a control signal in response to the detected parameters, the sensor being operably coupled to the media player; and a processing element which associates the control signal to at least one type of media preference, and causes the media player to provide media stimuli based on the control signal. Thus the media stimuli provided by the entertainment system is specific to the individual preferences and detected condition of the user.

U.S. Pat. No. 5,365,939 to Ochs, which is incorporated herein by reference, describes a method for treating an individual by use of electroencephalographic feedback by selecting a reference site for determining a brain wave frequency of the individual, entraining the detected brainwave frequency in one direction until a first predetermined stop condition occurs, and then entraining the brain wave frequency of the individual in the opposite direction until a second predetermined stop condition occurs. A method for assessing the flexibility of an individual with respect to treatment by electroencephalographic entrainment feedback includes selecting sites for determining brain wave frequencies of the individual, choosing one of the sites which has not been previously used for entrainment, entraining the brain wave frequency of the individual at the chosen site in one direction until a first predetermined stop condition occurs, entraining the brain wave frequency of the individual at the chosen site in the opposite direction until a second predetermined stop condition occurs, and then repeating the steps beginning with choosing a site until all sites have been tested.

Patent Application Publication No. US 2007/0173730 to Bikko, which is incorporated herein by reference, describes a breathing biofeedback device, having a microphone configured to acquire sounds of a user's breathing; a controller communicatively connected with the microphone, the controller processing the signals acquired by the microphone to produce an output signal, the controller processing the signal whereby the microphone signal is first pre-amplified to a voltage level to be processed by an audio envelope detector circuit, the envelope detector signal then fed into the analog-to-digital converter input of the controller allowing it to constantly sample the input volume level, the controller then controlling the output volume level fed to the headphones utilizing a digitally controlled variable-gain amplifier.

Patent Application Publication No. US 2004/0077934 to Massad, which is incorporated herein by reference, describes an apparatus including a first sensor to measure a first physiological variable, which is indicative of a voluntary action of the user. A second sensor to measure a second physiological variable, which is substantially governed by an autonomic nervous system of the user. Circuitry is adapted to receive signals from the sensors to generate an output signal which directs the user to modify a parameter of the voluntary action.

A common shortfall of neurofeedback models and of the prior art is that they generally require monitoring of the patient in a rehabilitation facility for a considerable length of time. Furthermore, the prior art has been primarily focused upon real-time sensing of certain biorhythmic activity from a patient in a treatment center and altering a biofeedback signal in response to the ongoing sensing from the patient. The available data shows that the vital first few months of recovery are plagued by faltering and failure in most instances. For most alcoholics and drug addicts, the persistence of cravings following successful detoxification in a rehabilitation center has led to chronic relapse issues. Moreover, It is well known that the longer the patient spends under the care of a physician or institution the higher the cost of the treatment.

The challenge of successful treatment often falls short in managing the change of a patient's environment from the safety of the treatment center to an unsafe environment outside and independent of the treatment center where there is no way to sense and control automatic behavior. Continuing therapeutic treatment has typically been a primary solution to relapse, and has been employed by numerous different techniques, including peer reinforcement groups, therapeutic communities, twelve step support groups, ALCOHOLICS ANONYMOUS, NARCOTICS ANONYMOUS, 12 step meetings, and reoccurring maintenance sessions with a clinical physician back in the rehabilitation center for an ongoing period of time. In the past, patients have then been left with the option of being cajoled, persuaded or in some instances forced to return to the treatment center or to seek access to help as by telephone. However, these methods continue to show high failure rates in situations where there is an immediate temptation or an addictive cue which can lead the patient to relapse due to impulsive behavior.

Treatment professionals, through personal experience estimate, and independent studies confirm, that the long-term success rate for treatment programs range from 3% to 8%. The treatment community actually uses the low success rate to motivate patients, often telling them that only ‘1 in 10’ “make it.” Because addictive cues associated with addicting behavior are simply not challenged outside the clinical atmosphere during treatment, patients never learn to de-associate cues with addicting behavior in the here and now spectrum. As a result, the percentage of patients who relapse remains high due to lack practice in real time. That is, much of the work undertaken at the rehabilitation center is essentially lost when the patient transitions to the outside world away from the center where risk of relapse may be great. It is this transitional living and outpatient treatment to which the present invention is directed.

Assessing the brain activity, using EEG recorded brain waves or brain signals, as it relates to abilities to learn, concentrate, controlling motions, and others is still a useful modality. The present invention utilizes measurements of these signals to summarize a custom profile for the patient (rEEG). This comprehensive analysis is used as a guide to re-train the specific areas of the brain using exercises that target specifically identified brain areas that have been compromised. Treatment of, for instance, alcohol and drug addiction is focused on addiction as a brain-based disease that affects the person's behavior, not necessarily a voluntary destructive behavior that must be changed. These advanced “brain exercises and activities” have been adapted to various modalities such as computer based neurotherapy biofeedback, cognitive development and acceleration, memory enhancements, relaxation techniques, stress management and other items. During sessions with the patient, brain activity is constantly monitored to study, fine tune and encourage progress in every step of the way.

Unlike the prior art, the device and method of the present invention does not require real time monitoring by sensors to respond at the time the patient is confronted with or observes an addictive cue. The invention eases the transaction from a rehabilitation center to the outside world by providing the patient with a transitional device which is immediately available to the patient when confronted with relapse situations outside the clinical atmosphere. The patient is trained beforehand to use the device when faced with addictive cues to conveniently and immediately recall focused treatment already screened by a clinical physician. Patients then connect what they learn at the treatment center to their home environment where they are at the highest risk of relapse and in need of the most support. The device and teachings of the present invention enable the patient to recall clinical treatment away from the treatment center and to resist temptation by feeling like the therapist is always at his or her side.

Thus, it can be seen that the present invention is useful in counteracting the effects of relapse from a wide variety of addicting substances or behaviors. Through its utilization, the patient can effectively function in a real-time environment independent of the persistent monitoring or confines of a treatment center without losing or making unavailable the work that has already taken place within the treatment center. The invention not only reduces the rate of relapse but significantly diminishes continued therapeutic maintenance costs.

### SUMMARY OF THE INVENTION

In accordance with the present invention there is therefore provided a method for treating a patient for dependency relapses. In one aspect, through relapse prevention using neurofeedback (RPNF) and rEEG, the patient is taught to achieve a particular mental state effective to counteract addictive cues, and a therapeutic signal associated with the particular mental state is recorded in a portable media device. The therapeutic signals may be in the form of a voice, music, image, or other audio or video. Multiple therapeutic signals may be recorded on the device to counteract one or more addictive cues. The portable media device has a selection menu with controls coordinated with an index to generate therapeutic signals to produce corresponding treatment stimuli for treating addicting cues and thus induce the patient toward a particular mental state to counteract the addicting cues.

In another aspect, the patient is tested at a treatment center to identify addictive cues which tend to trigger a respective dependency relapse. The patient is monitored to determine perceptible stimuli that induces the respective dependency relapse, and to determine an unconscious biological signal concurrently present. The unconscious biological signal sensed from the patient can be a brainwave, respiration, or heart rate. Characteristics are then identified in the unconscious biological signal that are indicative of the relapse and exhibited to the patient. Certain perceptible treatment stimuli effective to counteract the respective addictive cues are also selected and presented to the patient. The patient is then taught to consciously change his or her unconscious biological signal against the relapse in the presence of the perceptible treatment stimuli. The selected perceptible treatment stimuli is then synchronized to the unconscious biological signal and converted into corresponding recordable signals. The recordable signals are ultimately recorded in a portable media device in association with a selection menu system or index and the patient is enabled to use the controls of the menu to recall the treatment stimuli to further treat the dependency relapse.

The invention is now described in connection with certain preferred embodiments directed to a method for treating a patient for post clinical treatment of dependency relapses with reference to the following illustrative figures so that it may be more fully understood. Other features and advantages are inherent in the system and methods claimed and disclosed or will become apparent to those skilled in the art from the following detailed description and its accompanying designs.

### BRIEF DESCRIPTION OF THE DRAWINGS

FIG. 1 is a view of the device of a preferred embodiment of the present invention.

FIG. 2 is a flow chart illustrating a preferred embodiment of the method of the present invention.

FIG. 3 is a flow chart of a second embodiment of the method of the present invention.

FIG. 4 is a flow chart of a third embodiment of the method of the present invention.

### DETAILED DESCRIPTION OF THE PREFERRED EMBODIMENTS

In the following description of the preferred embodiment, reference is made to the accompanying drawings that form a part hereof, and in which is shown by way of illustration specific embodiments in which the invention may be practiced. This description is not to be taken in a limiting sense, but is made merely for the purpose of explaining the general principles of the invention. Accordingly, the invention will be described with respect to rehabilitative therapy methods and devices, and particularly those methods and devices adapted to influence physiological mannerisms in order to achieve a desired effect, such as by treating dependency relapses by stimulation or relaxation of a patient. It is to be understood that the methods and devices described herein also apply to other methods and devices for treating a patient for dependency relapse.

### Specifics of the Invention

Relapse often stems from a change in environment from the safety of a rehabilitation clinic to a real-world environment which may be generally unsafe considering the patient's inability to cope with stress or exposure to family members' substance abuse. When relapse occurs, the patient must return to the rehabilitation center for treatment. It is an object of the present invention to bridge the transition from the rehabilitation center back to outside life and thus bring the best part of the treatment environment into the present. This can be achieved by making available perceptible recorded audio and/or visual signals associated with the patient's biological system and the rehabilitation environment for access by the patient after release. When tempted, the patient will access the recorded information to recover a soothing stimuli intended to address the temptation. This may be the voice of the therapist wishing the patient well, reminder of the prior treatment learning at the institution, possibly accompanied by background music having a beat to coordinate with a relaxed brain, a relaxation stimulus to induce sleep, all possibly interlaced with bio-feedback such as visual or audio signals characteristic of the patient's brainwaves, breathing cycle and/or heartbeat. In this manner the patient has ready access to the appropriate stimuli to learn how to re-direct and train the brain to positive ideas.

It is known that EEG characteristics are associated with human behavior and some mental illnesses. It is understood that target brainwaves into sight and/or sound on a computer screen or speaker facilitate a therapist in teaching the patient how to avoid danger signals by changing his or her own brainwave.

The present method of relapse prevention utilizes neurofeedback (RPNF) to help the patient identify brainwaves associated with the mental state of relapse in the presence of addiction cues. The therapist teaches the patient to use mindfulness to steer away from the dangerous mental state. By selecting stimuli (such as images, words, or video clips) under the direction of a therapist and recording them in a recorder the patient will have the treatment program readily available when the temptation strikes outside the treatment center so as to accesses the recorded information for recall and support to prevent relapse.

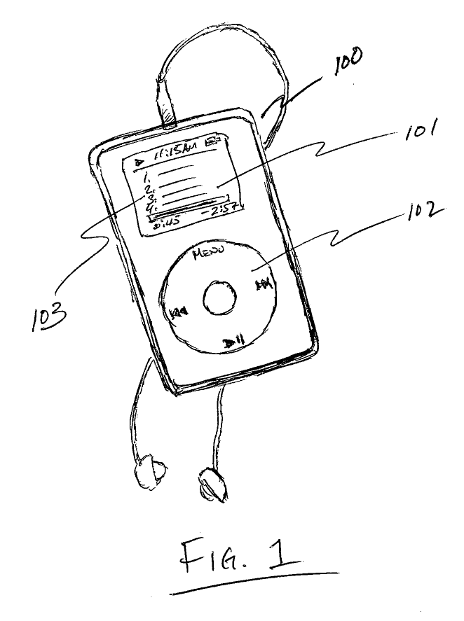

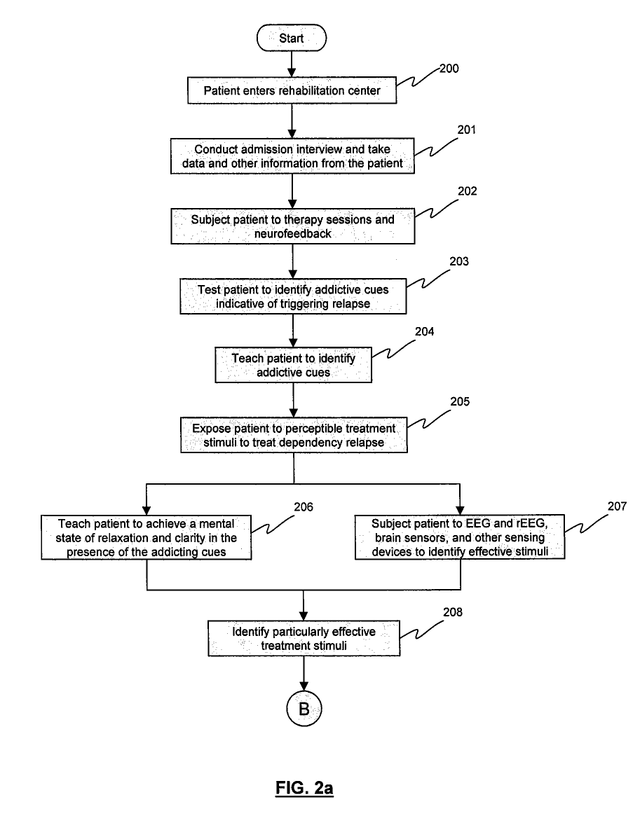

Referring to FIG. 1 the method of the present invention utilizes a portable media device 100 such as a tape recorder or MP3 player for recording of selected audio or visual signals effective for treatment of one or more relapse conditions of the patient is used. Multiple therapeutic signals can be recorded in the device and the signals may be recalled from the device using a selection menu 101. Selection menu 101 of the portable media device has controls 102 coordinated with the index 103 to recall the recordable signals. The preferred device is a common portable media device such as such as an IPOD™ or ZUNE™; however, any media device capable of recording audio and/or video and/or images such as a lap top or other personal computer to receive and store or transmit input will be sufficient without departing from the scope of the invention. The device is selected based on its ease of use and general acceptance by the public at large. Because of its inconspicuous nature, a portable recorder may be preferable as a device for rehabilitative treatment to minimize any resulting stigma upon the patient.

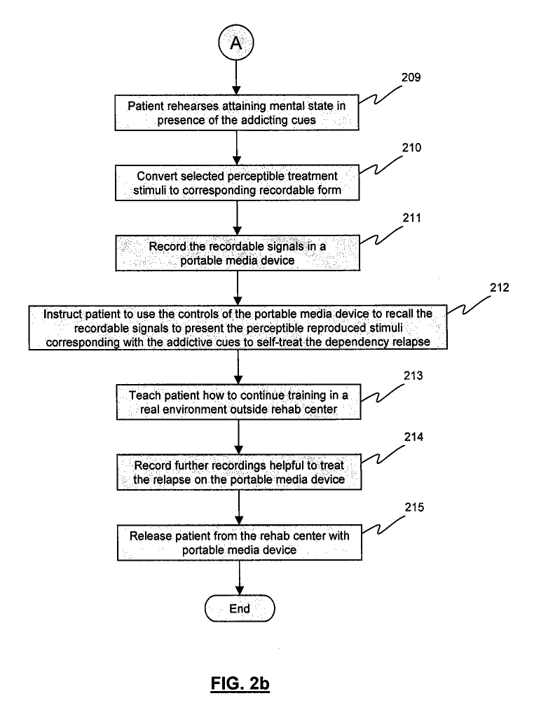

Referring to FIG. 2 when a patient elects to receive treatment for dependency, it is important to remove him or her to a treatment center 200 for evaluation and treatment. Personal data and information is taken from the patient at an admission interview 201. Once admitted, the patient is subjected to rehabilitation by therapy sessions 202 and neurofeedback over a period of a month or more. During this time, the patient is tested 203 to identify addictive cues indicative of triggering the dependency relapse. Addictive cues can be the viewing of certain addicting objects, or hearing certain sounds, or may arise from interpersonal interaction or relationships, and can also manifest from anxiety, fear, use of drugs, loneliness, or boredom. When presented to the patient addictive cues will often lead to dependency relapse for which treatment is sought. As part of a comprehensive treatment plan, the patient is taught 204 to identify the addictive cues.

The patient is exposed to perceptible treatment stimuli at 205 to treat the respective dependency relapses. The treatment stimuli can be in the form of images, words, audio or video signal, or can be a real-time perception or direct interaction with the patient while being placed in an environment which subjects the patient to relapse. Using the stimuli, the patient may be taught 206 how to create a mental state of relaxation, clarity, anti-boredom and/or anti-anxiety in the presence of the addicting cues. The patient is contemporaneously subjected to rEEG, brain sensors at 207, and other sensing devices and methods with the goal of identifying the stimuli most effective to treat the condition. The therapist records the results of the various treatments and identifies 208 particularly effective treatment stimuli. In some instances, the patient and therapist will work together to select the perceptible treatment stimuli. The patient then repeatedly rehearses 209 attaining the mental state until trained in the presence of the addicting cues to induce a state of relaxation or to counter the addicting cues. By this time the patient knows how to use the treatment stimuli to self-induce the mental state by observing the treatment stimuli in the presence of the addicting cues.

The selected perceptible treatment stimuli, if not already in a recordable form, is subsequently converted 210 to corresponding recordable signals. The recordable signals may take the form of audio such as a voice, music or other sound, or image or video, or any combination thereof. The voice may be that of a therapist or any other voice which is effective in treating the patient, such as that from a portion of a particularly effective therapy session or interview of the patient. The recordable signals are recorded at 211 in the portable media device 100 in association with index 103.

After several weeks of treatment, the patient is given the portable media device 100 and instructed 212 to recognize an addictive cue and how use selection menu 101 to recall the recorded reproduced treatment stimuli to, in the event the patient perceives the addicting cue, induce the patient toward the particular mental state effective to counteract the addicting cue and to self-treat the dependency relapse. The patient and therapist will continue to work together with the portable media device in conjunction with the patient's current treatment program at the treatment center. Accordingly, the patient is taught 213 how to continue training in a real-time environment using the portable media device.

After several weeks or months of treatment, depending on the progress detected by the therapist, the day will arrive for release back to the outside environment. An exit interview will be conducted and portions recorded for subsequent recall. The therapist will select portions of positive reinforcement greetings, compliments, sessions with peers, and good wishes for recording 214 on portable media device 100. The exit interview may include a summary of what to do and what not to do, and an explanation of what recordings have been placed on the portable media device. The patient is then released 215 from rehabilitation with portable media device 100 in his or her possession for access to the menu 101 to selectively call up positive and reinforcing stimuli.

The stimuli, now in the form of perceptible signals, include but are not limited to selected recorded portions of admission interviews, therapy sessions, the voice of therapist wishing the patient well, selected reminders of the lessons learned during rehabilitation to practice at home, selected recordings to encourage against attempted substance abuse, background music with a beat to coordinate with the patient's relaxed brainwaves, selected music to induce a state of anti-boredom and anti-anxiety, therapist voice message to induce a trans-like feeling or assist in regulating breathing and muscle relaxation, segments of the exit interview, and recorded peer good wishes. The patient can then continue to train his or herself with the portable media device in real situations outside the treatment center.

Ultimately, more frequent use of the device of the present invention reinforces what was learned during the stay at a rehabilitation center and greatly improves rehabilitative outcome by decreasing relapse frequency, shortening relapse time, and increasing sobriety duration. It is a reminder of the learning at the rehabilitation center which can be practiced at home. The patient uses the portable media device and the teachings of the present invention to listen to the recordings when tempted by relapse outside the treatment center and to feel like the therapist is at his or her side. It is especially beneficial that the device and method of the present invention is less conspicuous in public situations and the patient can use it anywhere right on the spot of an addicting situation.

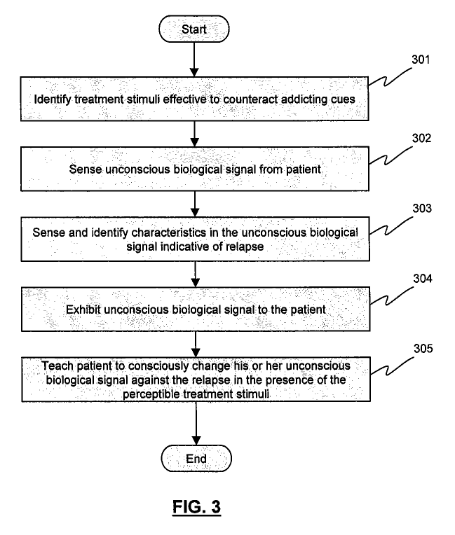

Referring to FIG. 3, the method of the present invention may also utilize unconscious biological signals. Once treatment stimuli effective to counteract the respective addictive cues is identified 301, the therapist may select certain unconscious biological signals, usually including at least one brainwave (EEG) or heartbeat or respiration, or some combination thereof, to be sensed 302 from the patient. Sensors are employed during examination of the patient to sense and translate the unconscious biological signals, and characteristics in the unconscious biological signal indicative of the relapse are identified 303. The unconscious biological signal is then exhibited 304 to the patient, and the patient is taught 305 to consciously change or modulate his or her unconscious biological signal against the relapse in the presence of the perceptible treatment stimuli. For instance, by changing his or her brainwave the patient can effectively avoid negative signals such as cravings or anxiety.

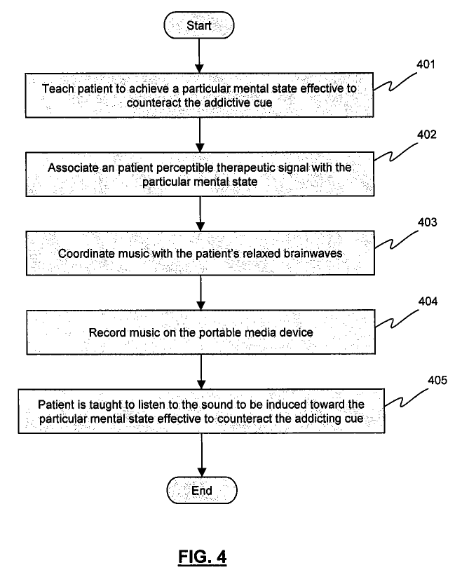

In a third embodiment of the method of the present invention, as illustrated in FIG. 4, after the patient is taught 401 at the rehabilitation center to achieve a particular mental state effective to counteract the addictive cue, a therapeutic signal, usually audio or video or image, or some combination thereof, is associated 402 with the particular mental state. Association is generally accomplished by sensing from the patient an unconscious biological signal contemporaneous with the particular mental state and then linking or synchronizing the therapeutic signal with the unconscious biological signal. Linking or synchronizing the therapeutic signal with the unconscious biological signal involves first translating the biological signal to a certain pattern or frequency and then matching the frequency or pattern of the perceptible treatment stimuli to the frequency or pattern of the biological signal.

With continued reference to FIG. 4, the therapeutic signal may be selected as a music having a beat synchronized to the unconscious biological signal. The music is coordinated 403 with the patient's relaxed brainwaves and is effective to induce a state of relaxation, clarity, anti-boredom and/or anti-anxiety. The music is recorded 404 on media device 100 in association with index 103. In yet another aspect the therapeutic signal is a bell sound having a frequency paired to the unconscious biological signal. As with the music described above, the sound of the bell facilitates relaxation. By listening to the music or the bell sound the patient is induced 405 toward the particular mental state effective to counteract the addictive cue.

The forgoing description of the invention has been presented for the purposes of illustration, and although the present invention has been described in detail with regard to the preferred embodiments and drawings thereof, it should be apparent to those of ordinary skill in the art that various adaptations and modifications of the present invention may be accomplished without departing from the spirit and the scope of the invention. Accordingly, it is to be understood that the detailed description and the accompanying drawings as set forth hereinabove are not intended to be exhaustive or to limit the breadth of the present invention. Many modifications and variations are possible in light of the above teaching. It is intended that the scope of the invention not be limited by this detailed description, but by the claims and the equivalents to the claims appended hereto.

We claim:

1. A method for treating a patient for a dependency relapse, including:
in a treatment center, testing the patient to identify addictive cues indicative of triggering the dependency relapse;
exposing the patient to perceptible stimuli to treat the respective dependency relapse;
examining the patient to select selected perceptible treatment stimuli effective to counteract the respective addictive cues;
converting the selected stimuli to corresponding recordable signals;
recording the recordable signals in a portable media device in association with an index, the portable media device having a selection menu with controls coordinated with the index to recall the recordable signals and produce reproduced stimuli corresponding with the treatment stimuli;
releasing the patient from the treatment center to a different venue; and
giving the patient possession of the portable media device to access the controls to, upon sensing the addictive cues, actuate the controls to produce the respective reproduced stimuli corresponding with the selected perceptible treatment stimuli.

2. The method of claim 1 that includes:
selecting the portable media device to be operable remote from the treatment center to treat identified triggering conditions.

3. The method of claim 1 for treating identified triggering conditions wherein:
exposing the patient to perceptible stimuli to treat the dependency relapse includes the steps of:
generating selected perceptible stimuli;
exposing the patient to the selected perceptible stimuli;
examining the patient to select the selected perceptible stimuli effective to treat the identified triggering conditions;
converting the selected stimuli to selected recordable signals; and
recording the selected recordable signals in the media device associated with selected menu controls.

4. The method of claim 1 wherein:
examining the patient to select selected perceptible treatment stimuli includes the step of sensing from the patient an unconscious biological signal present concurrently with the selected perceptible treatment stimuli.

5. The method of claim 4 wherein:
the selected perceptible treatment stimuli is an audio signal synchronized to the unconscious biological signal.

6. The method of claim 1 wherein:
the selected perceptible treatment stimuli is a visually perceptible signal.

7. The method of claim 1 wherein:
the selected perceptible treatment stimuli includes positive reinforcement from peers at the treatment center.

8. The method of claim 1 wherein:
examining the patient includes subjecting the patient to an EEG to secure a reproduction of the patient's brainwave;
identifying characteristics in the patient's brain wave indicative of the relapse;
exhibiting the brainwave to the patient; and
teaching the patient to consciously change his or her brainwave against the relapse.

9. The method of claim 1 wherein:
the dependency relapse is a condition selected from the group of anxiety, fear, use of drugs, loneliness, and boredom.

10. The method of claim 1 wherein:
the selected perceptible treatment stimuli is relaxing to the patient.

11. A method for treating a patient for a dependency relapse, including:
in a treatment center, testing the patient to identify addictive cues indicative of triggering the respective dependency relapse;
exposing the patient to perceptible stimuli to treat the dependency relapse;
examining the patient to select selected perceptible treatment stimuli effective to counteract the respective addictive cues;
converting the selected perceptible treatment stimuli to corresponding recordable signals;
recording the recordable signals in a portable media device of the type having controls coordinated with the recordable signals to recall the recordable signals as reproduced stimuli; and
instructing the patient to, in the event the patient senses one of the addictive cues, actuate the controls associated with the recorded signal pertaining to the selected perceptible treatment stimuli to treat the one of the addictive cues by perceiving the corresponding reproduced stimuli.

12. A method for treating a patient for a dependency relapse, including:
in a treatment center, testing the patient to identify addictive cues indicative of triggering the respective dependency relapse;
sensing from the patient an unconscious biological signal present concurrently with the perceptible stimuli, the unconscious biological signal comprising at least one brainwave;
identifying characteristics in the unconscious biological signal indicative of the relapse;
exhibiting at least a portion of the unconscious biological signal to the patient;
presenting to the patient perceptible treatment stimuli effective to counteract the respective addictive cues;
teaching the patient to consciously change his or her unconscious biological signal against the relapse in the presence of the perceptible treatment stimuli;
examining the patient to select selected perceptible treatment stimuli effective to counteract the addictive cues;
synchronizing the selected perceptible treatment stimuli to the unconscious biological signal;
converting the selected perceptible treatment stimuli to corresponding recordable signals;
recording the recordable signals in a portable media device in association with an index, the portable media device having a selection menu with controls coordinated with the index to recall the recordable signals and produce reproduced stimuli corresponding with the selected perceptible treatment stimuli;
releasing the patient from the treatment center to a different venue; and
enabling the patient to use the controls to recall the recordable signals to present perceptible reproduced stimuli corresponding with the addictive cues to treat the dependency relapse at the different venue.

13. A method of treating a patient for a dependency relapse comprising the steps of:
selecting an addictive cue indicative of the relapse;
teaching the patient to achieve a particular mental state effective to counteract the addictive cue;
associating a therapeutic signal with the particular mental state;
exhibiting the therapeutic signal to the patient;
teaching the patient to achieve the mental state when the patient perceives the therapeutic signal;
recording the therapeutic signal in a portable media device in association with an index, the portable media device having a selection menu with controls coordinated with the index to recall the therapeutic signal and produce reproduced stimuli corresponding with the therapeutic signal; and
enabling the patient to use the controls to recall the reproduced stimuli in the event the patient perceives the addicting cue to induce the patient toward the particular mental state effective counteract the addicting cue.

14. The method of claim 13 wherein:
the step of associating the therapeutic signal with the particular mental state includes sensing the patient for an unconscious biological signal associated with the particular mental state to generate a therapeutic signal and associating the therapeutic signal with the unconscious biological signal.

15. The method of claim 14 wherein:
the therapeutic signal is selected as a music having a beat synchronized to the unconscious biological signal.

16. The method of claim 14 wherein:
the therapeutic signal is a sound, the sound having a frequency paired to the unconscious biological signal.

17. The method of claim 13 wherein:
the therapeutic signal is an audio signal.

18. The method of claim 17 wherein:
the audio signal is a music.

19. The method of claim 17 wherein:
the audio signal is a bell sound.

20. The method of claim 13 wherein:
the therapeutic signal is a recording of at least a portion of a selected effective therapy session or a voice making a status.

21. The method of claim 13 wherein:
the therapeutic signal is a visual image.

22. The method of claim 13 wherein:
the therapeutic signal is a therapist's voice.
